(19) United States
(12) Patent Application Publication
(10) Pub. No.: US 2025/0086584 A1
(43) Pub. Date: Mar. 13, 2025

(54) INVENTORY MANAGEMENT DEVICE, SYSTEM, AND METHOD

(71) Applicant: Smart Label Solutions, LLC, Howell, MI (US)

(72) Inventors: Jeff Hudson, Howell, MI (US); Matthew Smith, Howell, MI (US); Michael McCracken, Howell, MI (US); Trevor Coykendall, Howell, MI (US)

(21) Appl. No.: 18/830,977

(22) Filed: Sep. 11, 2024

Related U.S. Application Data
(60) Provisional application No. 63/537,922, filed on Sep. 12, 2023.

(51) Int. Cl. G06Q 10/087; G06K 7/10; G06K 19/07

(52) U.S. Cl. CPC G06Q 10/087; G06K 7/10297; G06K 19/0723

(57) ABSTRACT

An inventory management device, system, and method that can be configured to increase radio frequency identification (RFID) read accuracy and diversity in warehouse-based applications and in other inventory management scenarios. In one implementation, the inventory management device comprises a transportable frame that at least partially surrounds a housing, the transportable frame having a motor attachment surface. The housing includes a radio frequency identification (RFID) interrogator and an RFID antenna. In some implementations, there is a second RFID antenna located in the housing, and the first RFID antenna is orthogonally offset from the second RFID antenna.

### TECHNICAL FIELD

The present disclosure relates generally to inventory management and tracking, and more particularly, to radio frequency identification (RFID) tracking systems and methods.

### BACKGROUND

Inventory management schemes using RFID technology have become increasingly popular, but challenges still exist to improve counting and location accuracy. Current systems provide RFID-based location determinations based on overhead fixed antennas trying to read tagged items in static locations. Some systems also require active tags mounted throughout a facility, which can be expensive as well. In addition to the increase in infrastructure costs and complexity, these systems do not promote any diversity in maintaining high read rates of asset tagged items. Handheld readers can help promote this diversity, but they are limited in output power, and it is prohibitively difficult to reach products located on high shelves, such as 20 feet or more in large warehouse-based implementations.

### SUMMARY

In accordance with one embodiment, there is provided an inventory management device comprising a transportable frame that at least partially surrounds a housing, the transportable frame having a motor attachment surface. A radio frequency identification (RFID) interrogator and an RFID antenna are located in the housing.

In some embodiments, the motor attachment surface is part of a longitudinally extending slot in a base of the transportable frame, the longitudinally extending slot being sized to accommodate one or more forks of a forklift.

In some embodiments, there is a second RFID antenna located in the housing, with each of the first and the second RFID antennas having a longitudinal axis and a width axis, and the longitudinal axis being longer than the width axis. The first RFID antenna is orthogonally offset from the second RFID antenna. A third RFID antenna can be located in the housing, and a fourth RFID antenna can be located in the housing. A blocking partition can be included that at least partially separates the first and the second RFID antennas from the third and the fourth RFID antennas. The first and the second RFID antennas and the third and the fourth RFID antennas can be symmetrically arranged with respect to the blocking partition.

In some embodiments, the RFID interrogator is configured to transmit an output power of 2 watts or more, or more particularly, at 4 watts or more.

In some embodiments, the inventory management device is used with an inventory management system. The system includes a plurality of passive location tags and a plurality of passive asset tags. The RFID interrogator is configured to activate the plurality of passive location tags and the plurality of passive asset tags, and the RFID antenna is configured to receive return signals from the plurality of passive location tags and the plurality of passive asset tags. The inventory management device can be configured to read one passive asset tag of the plurality of passive asset tags in a plurality of location areas to obtain a plurality of asset tag readings for the one passive asset tag. In some embodiments of the system, the inventory management device is configured to obtain a received signal strength indicator (RSSI) for each of the plurality of asset tag readings and use a highest RSSI to assign a location of the one passive asset tag.

In accordance with one embodiment, there is provided an inventory management device comprising a frame that at least partially surrounds a housing, a first radio frequency identification (RFID) antenna located in the housing, and a second RFID antenna located in the housing. Each of the first and the second RFID antennas have a longitudinal axis and a width axis, with the longitudinal axis being longer than the width axis. The first RFID antenna is orthogonally offset from the second RFID antenna.

In some embodiments, a third RFID antenna is located in the housing and a fourth RFID antenna is located in the housing. A blocking partition can at least partially separate the first and the second RFID antennas from the third and the fourth RFID antennas. The first and the second RFID antennas and the third and the fourth RFID antennas can be symmetrically arranged with respect to the blocking partition.

In some embodiments, the frame is a transportable frame having a motor attachment surface that is part of a longitudinally extending slot in a base of the transportable frame, the longitudinally extending slot being sized to accommodate one or more forks of a forklift.

In accordance with one embodiment, there is provided an inventory management method comprising the steps of reading an asset tag in a plurality of location areas, obtaining a received signal strength indicator (RSSI) for the asset tag in each of the location areas using a highest RSSI obtained to assign a location of the asset tag. A non-transitory, computer-readable storage medium can be included, the storage medium storing instructions thereon that when executed by one or more electronic processors causes the one or more electronic processors to carry out the method. In some embodiments, an inventory management device performs the reading and obtaining steps, the inventory management device having a transportable frame and a radio frequency identification (RFID) interrogator, with the RFID interrogator transmitting an output power of 2 watts or more.

It is contemplated that any number of the individual features or steps of the above-described embodiments and of any other embodiments depicted in the drawings or description below can be combined in any combination to define an invention, except where features or steps are incompatible.

### BRIEF DESCRIPTION OF THE DRAWINGS

Preferred example embodiments will hereinafter be described in conjunction with the appended drawings, wherein like designations denote like elements, and wherein:

FIG. 1 is a schematic view of an inventory management system according to one embodiment;

FIG. 2 is a schematic overhead view of an inventory management system according to another embodiment;

FIG. 3 is a perspective view of an inventory management device, such as one that can be used in the systems of FIGS. 1 and 2;

FIG. 4 is a side view of the inventory management device of FIG. 3;

FIG. 5 shows example electronics that can be used with the inventory management device of FIGS. 3 and 4;

FIG. 6 is a schematic representation of the inner components of the inventory management device of FIGS. 3 and 4, according to one embodiment;

FIG. 7 is a schematic, cross-section representation of the inner components of FIG. 6; and

FIG. 8 is a flowchart of an example inventory management method, which can be used with the systems and devices of FIGS. 1-7.

### DESCRIPTION OF THE ILLUSTRATED EMBODIMENTS

Described herein is an inventory management device, system, and method that can be implemented as a way to increase radio frequency identification (RFID) read accuracy and diversity in warehouse-based applications and in other inventory management scenarios. The systems and devices may incorporate strategically oriented RFID antennas and optimized power output to improve usage in larger scale inventory-based operations. In some embodiments, the inventory management device is used with material handling equipment to inventory a plurality of assets that are each associated with an RFID asset tag. The inventory management device includes an RFID interrogator and one or more antennas. An inventory management method is also disclosed herein, which can help manage configuration, database connection, data flow, and operability of one or more location algorithms. Advantageously, movement of the one or more antennas of the inventory management device past the asset tags, opposed to fixed interrogator and antenna systems, helps create diversity and development of a much higher tag acquisition rate. Additionally, the inventory management device is configured to be more easily moved throughout a facility, enhancing read rate and improving received signal strength indicators (RSSIs) for RFID tags located in the facility.

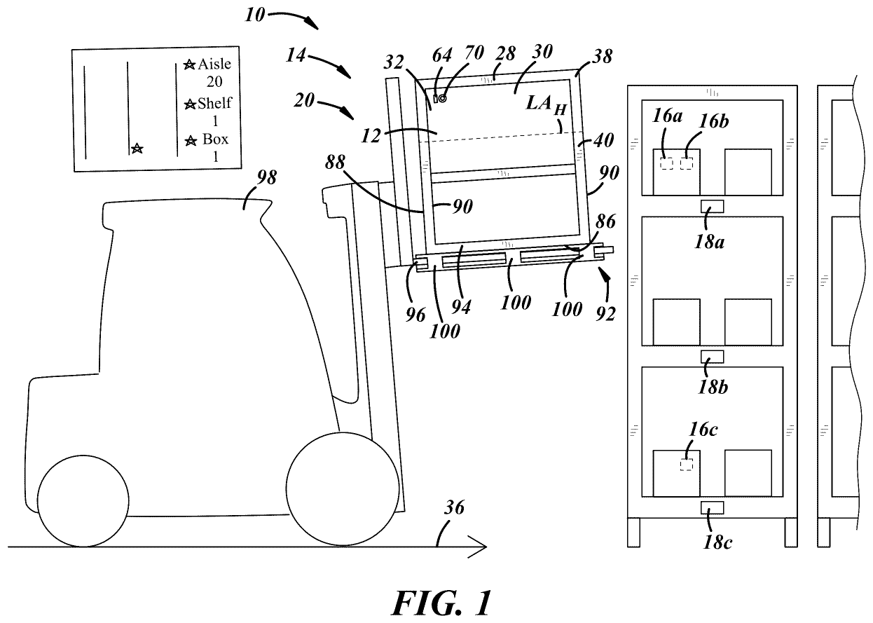

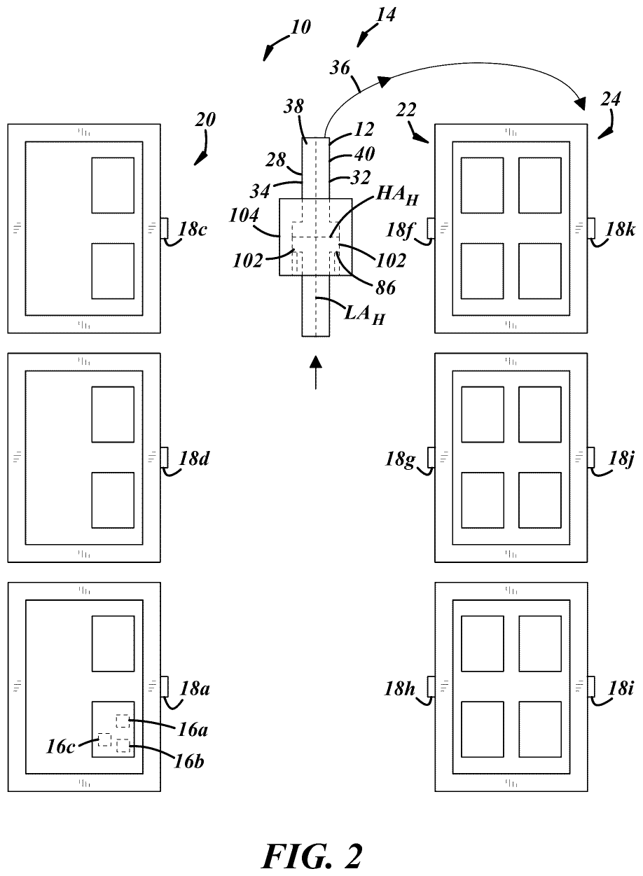

FIGS. 1 and 2 schematically illustrate embodiments of an inventory management system 10 and inventory management device 12. The inventory management system 10 and device 12 can be used in any operational facility 14, including but not limited to warehouses, manufacturing facilities, distribution centers, and other product storage centers, to cite a few examples. Inventory management may include location, counting, asset verification, or other inventory-related processes. The inventory management device 12 is configured to read a plurality of asset RFID tags 16a-c and a plurality of location RFID tags 18a-k located within the operational facility 14. It should also be emphasized that the drawings are not to scale, and in a typical operational facility 14, there could be thousands or even millions of asset RFID tags 16, and the number and arrangement of the location tags 18 will vary depending on the size and configuration of the facility. The inventory management system 10 and device 12 provide a technical advantage over overhead fixed antennas, as they minimize infrastructure cost and complexity, and help improve read rate and accuracy compared with handheld readers or the like. In some implementations, the inventory management system 10 and device 12 can reach products 20 ft or higher from the floor, as schematically represented in FIG. 1.

The system 10 and device 12 may be configured to travel within various zones or aisles 20, 22, 24. The structure of the zones 20, 22, 24 may have the aisle configuration as schematically shown in FIG. 2, or the zones could be alternately configured depending on the infrastructure within the operational facility 14. For example, an outdoor facility may not be constrained by a ceiling, or the aisles or zones 20, 22, 24 may be alternately shaped or configured depending on the desired implementation. As detailed more extensively below, the device 12 is configured to move through the facility 14 and inventory the plurality of asset RFID tags 16, while providing an estimated location for each asset RFID tag 16 within the facility and within each zone 20, 22, 24. In some embodiments, this location estimate can be provided via a graphical user interface 26 that is part of the system 10.

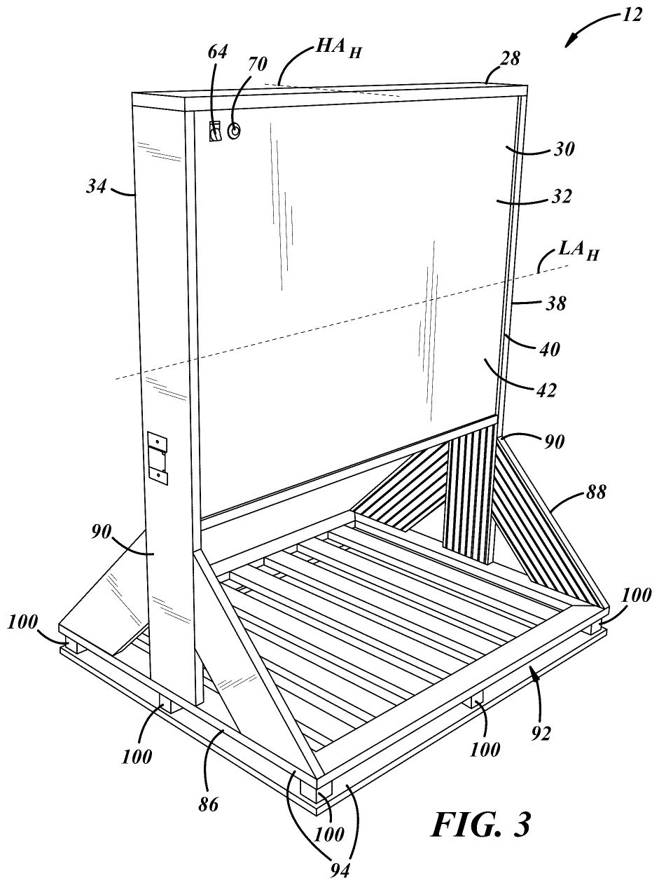

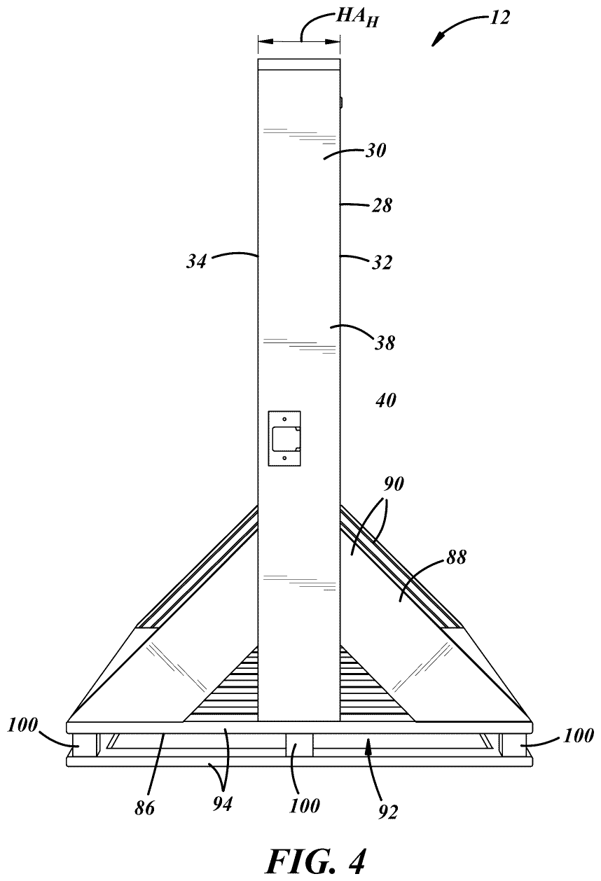

With particular reference to FIGS. 1, 3 and 4, the inventory management device 12 includes a transportable frame 28 that at least partially surrounds a housing 30. In the illustrated embodiment, the inventory management device 12 includes a first read side 32 and a second read side 34, which is opposite from the first read side 32. The first read side 32 and the second read side 34 are located on either side of a longitudinal axis LA_{H} that spans the longest extent of the housing 30 and the transportable frame 28. The housing 30 also has a horizontal axis HA_{H} which spans the width or depth of the housing 30. As shown in this implementation, the length of the housing 30 along the longitudinal axis LA_{H} is orders of magnitude longer than the width. This configuration allows for the first and second read sides 32, 34 to be better oriented with respect to the path of travel 36. Additionally, as illustrated, this arrangement provides for the longer longitudinal axis LA_{H} of the device 12 to be generally aligned with, or parallel to, the path of travel 36, which can help promote read rates within each zone 20, 22, 24 when they are configured as aisle-like structures.

The transportable frame 28 has an outer perimeter 38 that frames or outlines each of the first read side 32 and the second read side 34. The outer perimeter 38 serves as an exterior blocking partition 40, whereas the first read side 32 and the second read side 34 serve as exterior non-blocking partitions 42. As used herein, “blocking” and “non-blocking” relate to the ability of the material to allow adequate RFID signal transfer. For example, metal-based materials and water are generally considered more RF-opaque as they tend to reflect, slow down, and/or weaken RF transmission. These would constitute “blocking” materials. In another example, cardboard, plastics and foams, and some fibers are generally considered more RF-lucent as they tend to interfere less with RF signal transmission. These would constitute “non-blocking” materials. Accordingly, in this particular implementation, the transportable frame 28 and exterior blocking partitions 40 are made of a metal-based material such as aluminum, which also helps maintain a requisite level of durability in some embodiments. The first and second read sides 34 are made of cardboard or plastic, which helps accommodate adequate read range and accuracy. As shown in the illustrated embodiment, the device 12 is configured so that the exterior blocking partition 40 wholly surrounds each of the first and second read sides 32, 34, as well as the inner components of the housing 30.

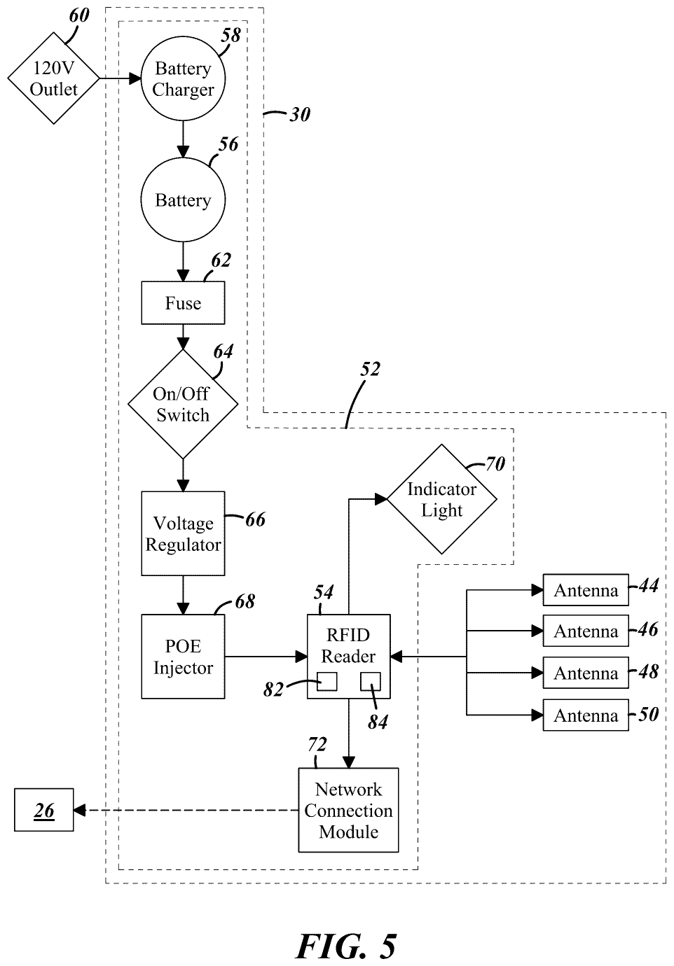

FIGS. 5-7 schematically represent the interior components of the housing 30. In addition to four antenna 44, 46, 48, 50, the other electronics 52 include an RFID reader or interrogator 54 and battery or power source 56. Using a battery as the power source 56 may be advantageous given the transportability of the device 12; however, other power source types are certainly possible. In the embodiment illustrated in FIG. 5, an onboard battery or power source 56 may also be coupled with a battery charger 58 accommodated to connect with a 120V outlet 60. The power source 56 helps power the antennas 44, 46, 48, 50, and the RFID interrogator 54 via a fuse 62, on/off switch 64, voltage regulator 66, and power over ethernet (POE) injector 68. Other electronics 52 may also include an indicator light 70 to help visually represent read status and a network connection module 72 to help facilitate data transmission. It should be understood that the electronics 52 may include other components, devices, etc., not particularly illustrated in the figures. Additionally, other wiring schemes, configurations, etc. are certainly possible.

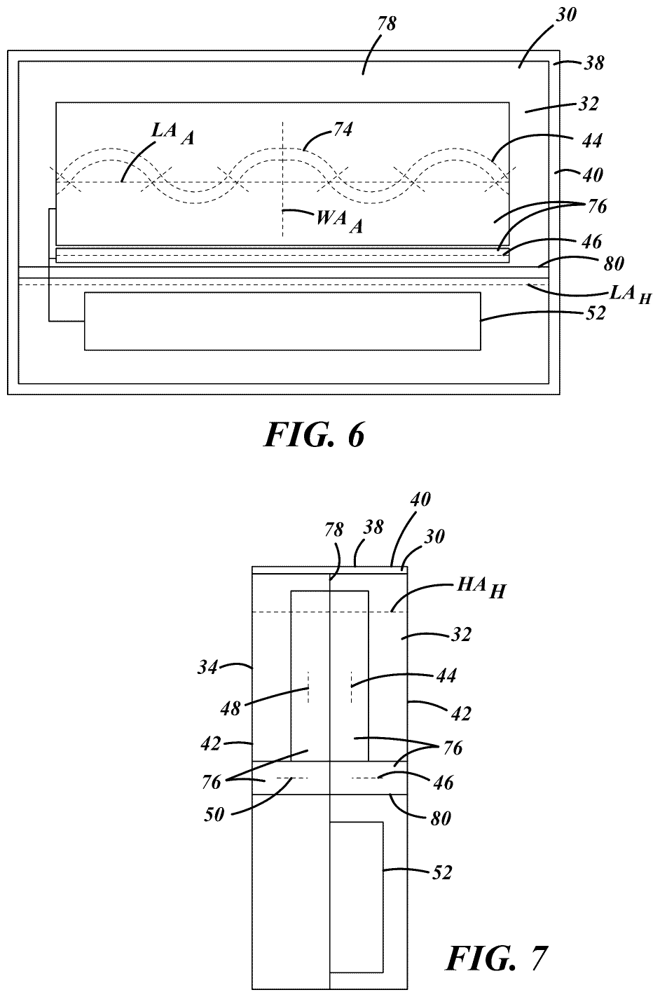

With reference to FIGS. 6 and 7, the inventory management device 12 includes a first RFID antenna 44, a second RFID antenna 46, a third RFID antenna 48, and a fourth RFID antenna 50. In some implementations, the inventory management device 12 includes less or more antennas than what is illustrated, and those antennas may be alternately configured depending on the desired implementation. However, the particularly illustrated configuration has the potential to improve read rate and accuracy, particularly in view of the antenna arrangements. Each antenna 44, 46, 48, 50 has a wave structure 74, as shown in FIG. 5. The antenna 44 and wave structure 74 are shown in phantom, as each antenna 44, 46, 48, 50 is sandwiched between interior non-blocking partitions 76 or foam layers that help impart structural integrity and proper positioning. The wave structure 74 of each antenna 44, 46, 48, 50 is detailed, for example, in U.S. Pat. No. 8,058,998 to Burnside et al., and incorporated by reference herein in its entirety. The wave structure 74 provides for multi-linear reading, which can be beneficial, particularly when the antennas 44, 46, 48, 50 are oriented as illustrated.

As shown in FIG. 6, the first antenna 44 and the second antenna 46 are located on the first read side 32, and they are oriented orthogonally with respect to each other. As used herein, “orthogonal” or “orthogonally” means +/−10° of being perfectly orthogonal. More particularly, each antenna 44, 46, 48, 50 has a longitudinal axis LA_{A} and a width axis WA_{A}, with the longitudinal axis LA_{A} being longer than the width axis WA_{A}. The first and second antennas 44, 46 are arranged such that the longitudinal axis LA_{A} and width axis WA_{A} of the first antenna 44 are orthogonally offset from the longitudinal axis and width axis of the second antenna 46. As shown, the length of each antenna 44, 46, 48, 50 is substantially longer than its width (e.g., the length and LA_{A} is about 7 ft, whereas the width and WA_{A} is about 1 ft), with the length or longitudinal axis LA_{A} configured to be running along the path of travel 36. Additionally, in this embodiment, the wave structure 74 and each undulation of the second antenna 46 are located in-plane with a plane cut or defined by the housing 30 longitudinal axis LA_{H}. This orthogonal arrangement, both respect to the antennas 44, 46 themselves, but also their alignment with respect to the housing 30 and frame 28, helps orient read regions more advantageously.

The third and fourth antennas 48, 50 have a similar orientation and configuration as the first and second antennas 44, 46. Given this, it is beneficial to have a first interior blocking partition 78 that blocks the first and second antennas 44, 46 from the third and fourth antennas 48, 50. As shown more particularly in FIG. 7, the antennas 44, 46, 48, 50 are symmetrically arranged with respect to the interior blocking partition 78. This promotes read regions to be strategically located on the opposite first and second read sides 32, 34, which run alongside the path of travel 36 when the device 12 is in motion. Additionally, a second interior blocking partition 80 may be included to shield the antennas 44, 46, 48, 50 from the other electronics 52.

The antennas 44, 46, 48, 50 cooperate with the RFID interrogator 54, which may be configured with its own electronic processor 82 and memory 84. The various electronics 52, antennas 44, 46, 48, 50, and GUI 26 may be directly coupled via a wired connection, or have any other operable coupling, such as Wi-Fi, short-range wireless communication (SRWC) or the like. The processor 82 may be any type of device capable of processing electronic instructions, including microprocessors, microcontrollers, host processors, controllers, and application specific integrated circuits (ASICs). It can be a dedicated processor used only for the interrogator 54, or it may be shared or used with other inventory management or assessment related devices. Processor 82 executes various types of digitally-stored instructions, such as software or firmware programs stored in memory 84. For example, processor 82 can execute programs or process data to carry out at least part of the inventory management methods discussed herein. Memory 84 may be a temporary powered memory, and any non-transitory computer readable medium, or other type of memory. For example, the memory can be any of a number of different types of RAM (random-access memory), ROM (read-only memory), solid-state drives (SSDs), hard disk drives (HDDs), magnetic or optical disc drives, etc. The processing of data and information from antennas 44, 46, 48, 50 may be accomplished by the dedicated interrogator 54 as schematically illustrated, or on an existing system or distributed architecture, to cite a few examples. In one implementation, the GUI 26 is associated with a local computer separate from the moveable device 12, with most processing being done at the interrogator 54, but it is possible for processing to be done at other locations beyond the device 12.

The inventory management device 12 is configured such that the power source 56 and the RFID interrogator 54 operate at greater than 2 W output power, and more preferably, at or exceeding 4 W output power. The output power may be either an effective radiated power (ERP) or effective isotropic radiated power (EIRP), and having it at greater than 2 W, or more preferably, at 4 W, allows for more tag reads and can improve signal strength. In one embodiment, the radiated power is set not to exceed 4 W to be in accordance with Federal Communications Commission regulations in the US. It should be also noted that the output power may be impacted by other factors, such as antenna gain or the like, but having the power level significantly higher than a handheld reader can improve inventory processing. For example, it is possible to operate at 2 W to power the antennas 44, 46, 48, 50, and with the antenna gain (e.g., about 3 dBi), less cable loss, the output power ends up around 3.7 W, which is stronger than a handheld reader, yet still in compliance with applicable regulations.

The combination of the increased output power, along with the transportability of the inventory management device 12, has been shown to increase processing reliability and results. Returning to FIGS. 1-4, the inventory management device 12 includes a transportable frame 28 having one or more motor attachment surfaces 86. The motor attachment surface 86 of the transportable frame 28 allows for the entire device 12 to be mechanically driven throughout the operational facility 14, which can improve the processing of tags 16, 18.

With reference to the embodiments illustrated in FIGS. 1, 3, and 4, the motor attachment surface 86 is part of a base 88 supported by legs 90. The base 88 can also be made of aluminum or another metal-based material such that it is an integral part of the transportable frame 28. The motor attachment surface 86 of the base 88 is configured as one or more longitudinally extending slots 92 that are located between two slotted panel portions 94. The longitudinally extending slot 92 is sized to accommodate one or more forks 96 of the forklift 98. In the illustrated embodiment, the longitudinally extending slot 92 is situated between support members 100 or spacers which separate the two slotted panel portions 94. The height of each of the support members 100 is sufficient enough such that the forks 96 of the forklift 98 can slide into the longitudinally extending slot 92 and subsequently carry the inventory management device 12 through the facility 14. In this embodiment, the slot 92 is bifurcated by another support member 100 in order to separately accommodate two forks 96 of the fork lift 98, which can help promote stability during transport. The motor attachment surface 86, however, can take other forms, such as a hook, arm, slot, or sleeve, to cite a few examples, and other operational features can serve to transport the transportable frame 28.

FIG. 2 shows another embodiment, in which the motor attachment surface 86 includes projections 102 located along an upper portion of the transportable frame 28. In this embodiment, a drone 104 is schematically illustrated as the motor driving the transportable frame 28. It should be understood, however, that the motor attachment surface 86 may change depending on the structure of the drive apparatus. Additionally, other motor-types are certainly possible, including automated guided vehicles (AGVs), track-based vehicles, etc. In an advantageous embodiment, the material handling equipment of the operational facility 14 is used without modification to transport the device 12. This allows existing resources to be employed without negatively impacting infrastructure costs. In other embodiments, the device 12 may have an integrated motor or other propulsion mechanism.

As schematically illustrated in FIGS. 1 and 2, the inventory management device 12 is configured to move throughout a plurality of zones 20, 22, 24 of the operational facility 14. The inventory management system 10 includes a plurality of passive active RFID tags 16a-c and a plurality of passive location RFID tags 18a-k, which are read via the interrogator 54 and antenna 44, 46, 48, 50 of the inventory management device 12. Some previous systems included multiple active tags or active readers stationarily located throughout the facility; however, with the system 10, passive tags 16, 18 are used, which can reduce infrastructure costs, as the passive tags do not require their own power source to broadcast their signal and instead rely upon the RF energy received from the transportable interrogator 54. In one implementation, the location tags 18 are located at intervals from each other that are about 10 feet apart, but this spacing may vary, depending on other factors such as output power of the interrogator 54.

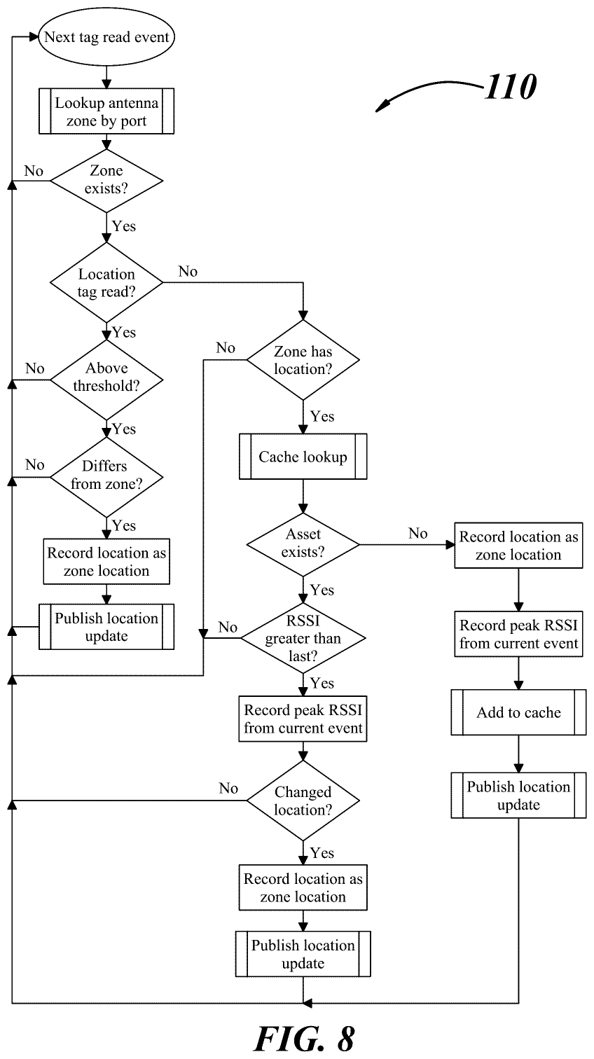

The movement of the device 12 along the path of travel 36 promotes read diversity for location-based tracking, and helps with reading asset tags 16 that may be located in various orientations or otherwise more challenging to read. FIG. 8 is a flowchart illustrating an example algorithm that can be used for an inventory management method 110, and ultimately used with the inventory management system 10. The method 110 uses the location algorithm to estimate the location of inventory or asset tags 16 in the facility 14. The resolution of the location is advantageously determined by the interval of location RFID tags 18 throughout the facility 14. The algorithm leverages understanding of the best received signal strength indicator (RSSI) read on a tag 16 and the nearest location tag 18 at the point of reading the best RSSI. Movement of the antennas 44, 46, 48, 50 of the device 12 past the asset tags 16 creates diversity for a much higher tag acquisition rate, and the antennas can moveably pass nearly any storage location in the facility 14. The method 110 may be carried out locally at the inventory management device 12 (e.g., as software stored on the memory 84 of the interrogator 54 and executed via processor 82), or at another operable location.

As shown in FIG. 8, the method 110 will publish location updates for asset tags 16 depending on a number of factors. In some embodiments, there will be an initial determination of whether one or more zones 20, 22, 24 exist. It is possible for certain antenna zones to be looked up via port. For example, as illustrated, there is a vertical right antenna 44, horizontal right antenna 46, vertical left antenna 48, horizontal left antenna 50, as shown in the device 12 (see e.g., FIG. 7), and it may be known via the path of travel 36 that the vertical left antenna 48 and the horizontal left antenna 50 are configured to read zone 20, whereas the vertical right antenna 44 and the horizontal right antenna 46 are configured to read zone 22 (see e.g., FIG. 2). The method 110 determines whether there is a location tag reading and if so, compares the location tag reading to a location tag threshold. In one example, the location tag reading threshold is −55 RSSI, but may vary depending on the specifications of the system 10 and the configuration of the operational facility 14. Typically, about −85 RSSI is relatively weak, whereas about −30 is relatively strong. Having a higher location tag threshold, as compared to an RSSI threshold for asset tags 16, can help more accurately determine zone locations and promote more accurate asset tracking.

As shown in FIG. 8, if there is not a location tag read, the method 110 can see if the zone 20, 22, 24 has an associated location, do an optional cache lookup, and then see if an asset tag 16 is read. If an asset tag was not previously read, e.g., if it is a first read event, the method 110 goes on to record the location as the zone location, record the peak RSSI from the current event, add it to the cache, and publish a location update. This can essentially set the first read and then anything after can serve to iteratively update the initial information received while in the respective zone 20, 22, 24.

The method 110 also provides for publishing/assigning a location based on the readings received from the asset tags 16. If an asset tag 16 is read, the method 110 will record location when it receives the best RSSI reading from the asset tag. Accordingly, in some embodiments, the method 110 may compare the reading from an asset tag 16 to a dynamic threshold, or a cache or database of previously measured RSSI to help determine if a location change has occurred. For example, with reference to FIG. 1, if asset tag 16c used to be located with asset tags 16a and 16b, but it has now been moved, the method 110 may get location readings from each of the location tags 18a-c. Accordingly, in a plurality of location areas (e.g., about 10 feet or more from each location tag 18a-c), there may be a reading from asset tag 16c at the first location area associated with location tag 18a, the second location area associated with location tag 18b, and the third location area associated with location tag 18c. If the signal strength RSSI of the asset tag 16c is strongest at the strongest read cycle for location area at location tag 18c, a location publication update can be issued for that asset tag 16c. This can help enhance the location accuracy and count reliability.

It is to be understood that the foregoing description is of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” and “such as,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all the following: “A”; “B”; “C”; “A and B”; “A and C”; “B and C”; and “A, B, and C.”

1. An inventory management device, comprising:
a transportable frame that at least partially surrounds a housing, the transportable frame having a motor attachment surface;
a radio frequency identification (RFID) interrogator located in the housing; and
an RFID antenna located in the housing.

2. The inventory management device of claim 1, wherein the motor attachment surface is part of a longitudinally extending slot in a base of the transportable frame, the longitudinally extending slot being sized to accommodate one or more forks of a forklift.

3. The inventory management device of claim 1, further comprising a second RFID antenna located in the housing, wherein each of the first and the second RFID antennas have a longitudinal axis and a width axis, with the longitudinal axis being longer than the width axis, wherein the first RFID antenna is orthogonally offset from the second RFID antenna.

4. The inventory management device of claim 3, wherein a third RFID antenna is located in the housing and a fourth RFID antenna is located in the housing.

5. The inventory management device of claim 4, wherein a blocking partition at least partially separates the first and the second RFID antennas from the third and the fourth RFID antennas.

6. The inventory management device of claim 5, wherein the first and the second RFID antennas and the third and the fourth RFID antennas are symmetrically arranged with respect to the blocking partition.

7. The inventory management device of claim 1, wherein the RFID interrogator is configured to transmit an output power of 2 watts or more.

8. The inventory management device of claim 7, wherein the RFID interrogator is configured to transmit the output power at 4 watts or more.

9. An inventory management system comprising the inventory management device of claim 1, wherein the system comprises:
a plurality of passive location tags; and
a plurality of passive asset tags, wherein the RFID interrogator is configured to activate the plurality of passive location tags and the plurality of passive asset tags, and the RFID antenna is configured to receive return signals from the plurality of passive location tags and the plurality of passive asset tags.

10. The inventory management system of claim 9, wherein the inventory management device is configured to read one passive asset tag of the plurality of passive asset tags in a plurality of location areas to obtain a plurality of asset tag readings for the one passive asset tag.

11. The inventory management system of claim 10, wherein the inventory management device is configured to obtain a received signal strength indicator (RSSI) for each of the plurality of asset tag readings and use a highest RSSI to assign a location of the one passive asset tag.

12. An inventory management device, comprising:
a frame that at least partially surrounds a housing;
a first radio frequency identification (RFID) antenna located in the housing; and
a second RFID antenna located in the housing, wherein each of the first and the second RFID antennas have a longitudinal axis and a width axis, with the longitudinal axis being longer than the width axis, wherein the first RFID antenna is orthogonally offset from the second RFID antenna.

13. The inventory management device of claim 12, wherein a third RFID antenna is located in the housing and a fourth RFID antenna is located in the housing.

14. The inventory management device of claim 13, wherein a blocking partition at least partially separates the first and the second RFID antennas from the third and the fourth RFID antennas.

15. The inventory management device of claim 14, wherein the first and the second RFID antennas and the third and the fourth RFID antennas are symmetrically arranged with respect to the blocking partition.

16. The inventory management device of claim 12, wherein the frame is a transportable frame having a motor attachment surface.

17. The inventory management device of claim 16, wherein the motor attachment surface is part of a longitudinally extending slot in a base of the transportable frame, the longitudinally extending slot being sized to accommodate one or more forks of a forklift.

18. An inventory management method, comprising the steps of:
reading an asset tag in a plurality of location areas;
obtaining a received signal strength indicator (RSSI) for the asset tag in each of the location areas; and
using a highest RSSI obtained to assign a location of the asset tag.

19. A non-transitory, computer-readable storage medium storing instructions thereon that when executed by one or more electronic processors causes the one or more electronic processors to carry out the method of claim 18.

20. The inventory management method of claim 18, wherein an inventory management device performs the reading and obtaining steps, the inventory management device having a transportable frame and a radio frequency identification (RFID) interrogator, wherein the RFID interrogator transmits an output power of 2 watts or more.
